(19) United States
(12) Patent Application Publication
(10) Pub. No.: US 2002/0166407 A1
(43) Pub. Date: Nov. 14, 2002

(54) Steering wheel with heat accumulating mechanism

(75) Inventors: Michael Germuth-Loffler, Aschaffenburg (DE); Jurgen Bender, Frankfurt (DE); Martin Paul, Freisen (DE)

Correspondence Address: FOLEY AND LARDNER, SUITE 500, 3000 K STREET NW, WASHINGTON, DC, 20007, US

(73) Assignee: TAKATA-PETRI AG

(21) Appl. No.: 10/125,576

(22) Filed: Apr. 19, 2002

Related U.S. Application Data
(63) Continuation of application No. PCT/DE00/03775, filed on Oct. 19, 2000.

(30) Foreign Application Priority Data
Oct. 20, 1999 (DE) 199 51 323.6

(51) Int. Cl. B62D 1/04

(52) U.S. Cl. 74/552

(57) ABSTRACT

A steering wheel for a motor vehicle, which includes a heat accumulating mechanism is provided. The heat accumulating mechanism is located in at least two spatially separated areas of the component part, thereby making it possible to modify the temperature of the steering wheel in a particularly efficient manner.

This is a continuation of International Application PCT/DE00/03775, filed on Oct. 19, 2000.

### BACKGROUND

The invention relates to a component part comprising a heat accumulating mechanism.

Component parts, such as for example steering wheels of motor vehicles, become very hot in summer, in particular as a result of direct solar radiation. At low temperatures in winter, steering wheels cool down quickly after the vehicle has been left. Therefore, controlling the temperature of component-part surfaces is a matter of comfort. However, safety is also impaired by component parts which are at an incorrect temperature, since a steering wheel which is too hot or too cold is generally not held firmly enough, and consequently driving safety is impaired.

DE 34 38 266 A1 (incorporated by reference herein) has disclosed a device for heating and cooling a steering wheel, in the steering-wheel rim of which thermoelectric transformers are arranged, the heat-generating or heat-absorbing sections of which generate or absorb heat according to the current direction applied. A hollow core part is arranged in the interior of the steering wheel, the interior of this hollow core part holding a heat-accumulating and/or heat-conducting fluid. The evaporation of this fluid increases the heat capacity of the steering wheel, and heating of the steering-wheel surface is avoided. The use of a single location for accommodating a heat accumulating medium is disadvantageous, since the heat transfer in the steering wheel is adversely affected.

### SUMMARY OF THE INVENTION

An object of the present invention is to provide a steering wheel, in which the temperature control is improved.

According to one embodiment of the present invention a steering wheel is provided. The steering wheel includes at least two regions for the heat accumulating mechanism, which are arranged spatially separate in the component part, allows the heat accumulating mechanism to be used in a more spatially targeted manner in the component part than if the heat accumulating mechanism were concentrated at only one location in the component part. This improves the heat transfer and therefore the temperature control of the steering wheel. In particular, the spatial separation of the regions ensures that, compared to a single region, in each case smaller regions of the heat accumulating mechanism have to be cooled or heated. A plurality of regions have a larger surface area than a single region, which contributes to improving the heat transfer. Also, by suitably arranging the spatially separate regions in the component part, mass forces can be distributed better.

In one advantageous configuration of the invention, the component part at least partially comprises a porous material, in particular plastic. The pores have, as heat accumulating mechanism, a phase change material, which can change its state of aggregation within the operating temperatures of the component part. When the state of aggregation changes (also known as a phase change), energy is consumed or released, so that the more energy-rich phase can serve as a heat store. Accordingly, the lower-energy phase can serve as a heat sink. For example, heat of evaporation is required in order to convert a substance from the liquid state to the gaseous state. The gas can therefore be used as a heat store, the energy of which is released again during condensation as heat of condensation. A similar statement applies to a liquid-solid phase change, during which heat of fusion is consumed, or heat of solidification is released, and for sublimation processes in the event of a solid-gas phase change.

In a particularly advantageous configuration of the invention, Freon or water are used as phase change material. These substances are particularly well suited to use as heat accumulating mechanism.

In a further advantageous configuration, the component part at least partially comprises a porous material, in particular plastic, the pores of which have, as heat accumulating mechanism, a heat accumulating medium. At the standard operating temperatures of the component part, the heat accumulating medium retains its state of aggregation. In this case, the heat is accumulated by mechanism of the heat capacity of the heat accumulating mechanism.

Advantageously, in this case, at least one heat accumulating medium has water with antifreeze, pieces of metal, metal powder, glycol, gel and/or oil as heat accumulating medium. These substances are particularly suitable as heat accumulating medium, on account of their heat capacity.

The heat accumulating mechanism is advantageously arranged in partial regions, in particular grip zones of the component part. In this way, it is possible to select an arrangement, which is matched to the user, so that particular comfort during operation is achieved.

The invention is explained in more detail below with reference to the figures of the drawings and on the basis of a plurality of exemplary embodiments. In the drawings:

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a front view of a steering wheel;

FIG. 1a is a side view of the steering wheel;

FIG. 2 is a sectional view taken along line A-A of FIG. 1;

FIG. 3 is a sectional view taken along line A-A of FIG. 1 in a different embodiment of the steering wheel;

FIG. 4 is a sectional view taken along line A-A of FIG. 1 of the steering wheel with a heat accumulating mechanism in an outer layer of the cladding;

FIG. 5 is a sectional view on A-A of FIG. 1 of the steering wheel with a heat accumulating mechanism in the entire cladding of the steering wheel;

FIG. 6 is a sectional view on A-A in FIG. 1 of the steering wheel with a heat accumulating mechanism in a partial region of the steering-wheel cladding;

FIG. 7 is a schematic view of the steering wheel with partial regions which have an elevated concentration of heat accumulating mechanism;

FIG. 8 is a graph illustrating the steering-wheel temperature as a function of the thermal energy taken up, with and without phase change material.

### DETAILED DESCRIPTION

In the figures, the present invention is explained on the basis of a steering wheel. However, according to the present invention, to control the temperature of other component parts, such as for example control sticks, gear levers, switch knobs, handles, cranks, handbrake grips, seatbelt buckles, seat surfaces, seat backrests, headrests, gear shift levers or switches. The term temperature control is understood as meaning cooling or heating to a predeterminable temperature. At any rate, an object is to avoid component parts which are too hot or too cold for a user.

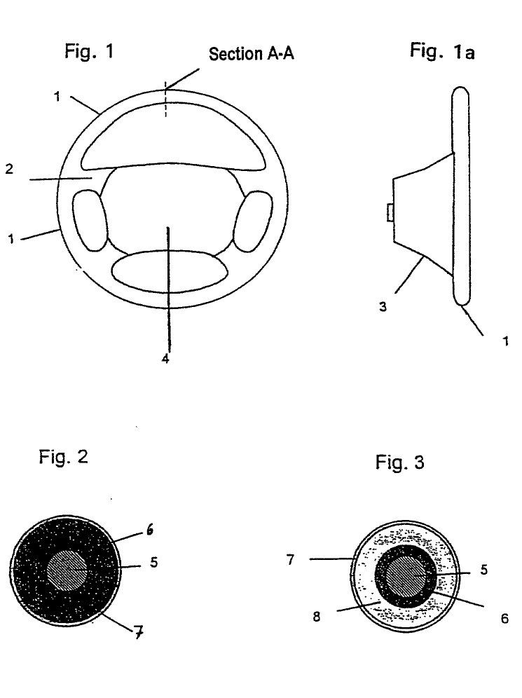

FIGS. 1 and 1a show a steering wheel having the typical regions steering-wheel rim 1, steering-wheel spokes 2, steering-wheel body 3 and airbag unit 4. A steering wheel of this type is used, for example, in motor vehicles of all types.

FIG. 2 shows the typical internal structure of a steering wheel. The section plane A-A is illustrated in FIG. 1. The steering wheel itself is formed, in the core, from a skeleton 5. The skeleton 5 is surrounded by a cladding 6 and a covering 7 (e.g. of leather). Other steering wheels have an internal structure such as that illustrated in FIG. 3, in which the skeleton 5 is surrounded by a hard cladding 6 (e.g. of hard foam) and a soft cladding 8 (e.g. soft foam).

In the case of the items illustrated in FIGS. 2 and 3, the skeleton 5 consists of solid material. Alternatively, the skeleton 5 may also be formed from a steel-tube structure with a hollow profile or from a cast aluminum or magnesium structure. Alternative embodiments of the present invention may also have a non-circular shape of steering wheel.

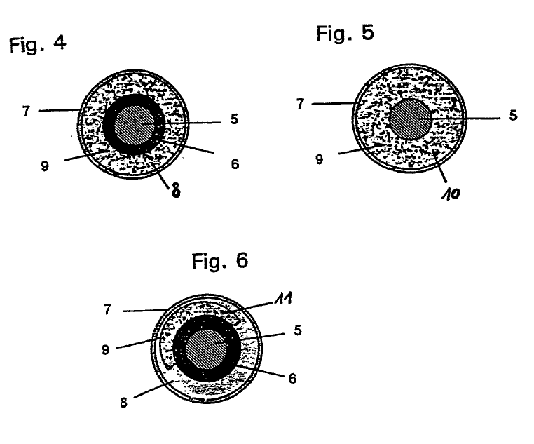

FIG. 4 illustrates a cross section through a steering wheel in accordance with FIG. 3. The embodiment illustrated in FIG. 4 has, in the soft cladding 8, pores are provided as a heat accumulating mechanism 9 for storing a phase change material. The pores are spatially distributed throughout the soft cladding 8; they form the spatially separate regions. Although the present embodiment uses a very large number of pores, in alternative embodiments it is also possible for only two spatially separate regions with a heat accumulating mechanism 9 to be arranged in the component part, in order to locally improve the heat transfer.

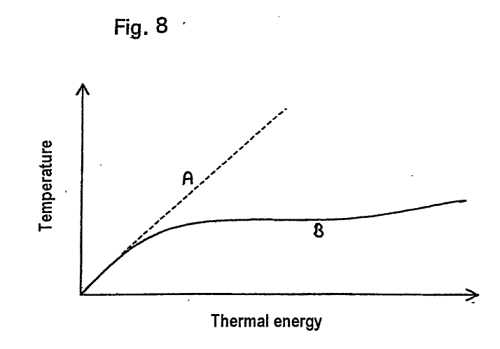

In the context of the present invention, the term spatially separate mechanism means that the heat accumulating mechanism is not arranged in a single, continuous region (e.g. a hollow tube) in the component part, but rather is distributed in individual regions (e.g. pores) through the component part. However, these regions having the heat accumulating mechanism do not have to be distributed uniformly throughout the entire component. As illustrated in FIG. 8, for example, the heat accumulating mechanism may also deliberately be arranged in some partial regions (e.g. grip zones) of the steering wheel. In this case too, there are spatially separate regions of the heat accumulating mechanism.

The phase change material used in this case is Freon, which evaporates under the action of heat (e.g. solar radiation onto the steering wheel). Alternatively, it is also possible to use water at a low pressure or a metal alloy. With these substances, a change in the state of aggregation is possible at the standard operating temperatures of the component part (e.g. −40° C. to 100° C.). The phase change energy required for this purpose (e.g. melting energy, evaporation energy) is used to accumulate heat in the component part.

In the present example, the heat required for evaporation prevents the steering-wheel surface from being heated excessively. Since the heat transfer coefficient between the wall of the pores and the gaseous phase change material is very much worse than that between the wall of the pores and a liquid phase change material, the steering wheel surface is not heated to such an extent.

In a further embodiment, which is illustrated in FIG. 5, the entire cladding 10 of the steering wheel is provided with pores as mechanism for storing the liquid phase change material. The phase change material functions to reduce the temperature of the steering wheel surface in a manner similar to the embodiment illustrated in FIG. 4.

In the embodiment illustrated in FIG. 6, the steering wheel has a partial region 11 in which pores are arranged as mechanism for accommodating a phase change material. There are no pores arranged outside the partial region 11. In the embodiment of FIG. 6, for example, the upper region of a steering wheel, which is exposed to particularly intense solar radiation, can be particularly well protected against overheating at these locations.

In an alternative embodiment, the density of the pores in the partial region 11 may be increased as compared to the pore density in the remaining regions of the soft cladding 8.

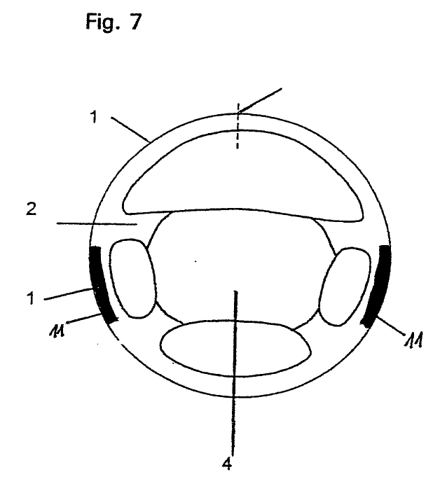

In FIG. 6, the partial region 11 is arranged over an angular region in the cross section of the steering-wheel rim 1. In a further embodiment, partial regions 11 are arranged at typical grip zones of the steering-wheel rim 1, as illustrated in FIG. 7. The arrangement of the partial regions 11 in the grip zones of the steering wheel increases operating comfort.

FIG. 8 is a graph of the temperature at the steering-wheel surface versus the thermal energy taken up by the heat accumulating mechanism. Curve A represents the temperature profile produced when no heat accumulating mechanism is used; and the steering-wheel surface is heated to an ever increasing degree.

By contrast, curve B shows a significantly reduced rise in the temperature, since in this case the heat accumulating mechanism arranged in the steering wheel takes up heat, and thereby prevents the steering-wheel surface from being heated excessively. The same relationships apply in a similar way to cooling, which takes place more slowly on account of the heat stored in the heat accumulating mechanism.

The design of the invention is not restricted to the preferred exemplary embodiments which have been outlined above. Rather, a number of variants which make use of the component part according to the invention even in fundamentally different designs are conceivable.

What is claimed is:

1. A steering wheel for a motor vehicle, comprising:
a heat accumulating mechanism arranged in at least two spatially separate regions of the component part;
wherein the steering wheel comprises a porous material having pores containing a phase change material which can change its state of aggregation within the standard operating temperatures of the steering wheel.

2. The steering wheel of claim 1, wherein the phase change material includes Freon.

3. The steering wheel of claim 1, wherein the phase change material includes water.

4. The steering wheel of claim 3, wherein the heat accumulating mechanism includes water with an antifreeze, pieces of metal, metal powder, glycol, gel and/or oil as a heat accumulating medium.

5. The steering wheel of claim 1, wherein the heat accumulating mechanism is arranged in grip zones of the steering wheel.
